(19) United States
(12) Patent Application Publication
(10) Pub. No.: US 2010/0227943 A1
(43) Pub. Date: Sep. 9, 2010

(54) METHODS FOR CONTROLLING GLOSS IN PHOTOPOLYMERIZED COATINGS, FILMS AND SURFACES

(76) Inventors: Chris Coretsopoulos, Iowa City, IA (US); Alec B. Scranton, Coralville, IA (US); Peter Ganahl, Ringgold, GA (US)

Correspondence Address: Ballard Spahr LLP, SUITE 1000, 999 PEACHTREE STREET, ATLANTA, GA, 30309-3915, US

(21) Appl. No.: 12/594,960

(22) PCT Filed: Apr. 9, 2008
(86) PCT No.: PCT/US08/59784

§ 371 Date: Apr. 21, 2010

Related U.S. Application Data
(60) Provisional application No. 60/910,776, filed on Apr. 9, 2007.

(51) Int. Cl. C08F 2/46

(52) U.S. Cl. 522/182

(57) ABSTRACT

Disclosed are methods for producing photopolymerized compositions having controlled surface morphology. The method of the present invention generally comprises a two step illumination process in which a photopolymerization system is first illuminated according to a predetermined spatial and temporal illumination scheme comprised of a pattern of varying light intensities incident on a surface portion of the photopolymer system. The pattern of varying light intensities initiates photopolymerization at varying rates of polymerization across the surface portion of the photopolymerization system. After completion of the predetermined spatial and temporal illumination scheme, the photopolymerization system is illuminated in a flood cure step to achieve a uniformly cured polymer composition having the controlled surface morphology. The controlled surface morphology of the resulting polymer composition enables the production of polymer surfaces having controlled loss characteristics.

### CROSS-REFERENCE TO RELATED APPLICATIONS

This application claims the benefit of priority to U.S. Provisional Patent Application No. 60/910,776, filed Apr. 9, 2007, the entire disclosure of which is incorporated by reference herein for all purposes.

### STATEMENT REGARDING FEDERALLY SPONSORED RESEARCH FOR DEVELOPMENT

This invention was made with government support under NSF Industry/University Cooperative Research Center (IUCRC) Grant Number 0002971, awarded by NSF. The United States Government may have certain rights in the invention.

### FIELD OF THE INVENTION

The present invention relates generally to photopolymerization methods and, more particularly, to methods for controlling the surface morphology of photopolymerized compositions.

### BACKGROUND OF THE INVENTION

Polymer systems can be used in a variety of applications, including coatings and films, to provide protective barriers and/or desirable surface properties. The use of polymer coatings can, for example, substantially affect the function and appearance of a surface by altering the gloss, or reflection of light incident on the surface.

Specific applications can require a controlled gloss for aesthetic and/or functional reasons. For example, high gloss finishes are typically desirable in the automotive industry. In contrast, high gloss finishes are typically undesirable in applications involving finished wood, such as cabinetry, flooring, and furniture. High gloss finishes in such applications can provide a “plastic” or “unnatural” appearance, undermining the apparent value of a product.

Control of gloss can also be important in other applications, such as display technologies, where glare from high gloss surfaces can adversely affect the ability to view an image. To reduce gloss and the resulting glare, displays and other optical components typically use antireflective or low gloss films.

In general, the smoothness or roughness of a surface will influence the manner in which light is reflected from a surface, as illustrated in FIG. 1. As shown, a smooth surface 110 can generate specular reflections 120 of incident light 115, thus providing the appearance of a high-gloss, mirror-like surface. In contrast, a rough surface 130 can generate diffuse reflections 140 of incident light 115, thus providing the appearance of a low-gloss, dull surface.

Traditional approaches to controlling gloss include the addition of filler materials to the polymerization system and/or the use of secondary or post polymerization mechanical or chemical processing steps. For example, FIG. 2 schematically illustrates the addition of silica particles as a filler to a polymerization system. As shown, a wet or uncured film 210 is provided comprising silica particles 220. After polymerization, a cured film 230 is provided also comprising the silica filler particles 220. As a result of the filler particles, the cured film has a roughened surface 240. Several drawbacks can however result from these traditional techniques. Although the addition of a filler material to a polymerization system can result in a micro-roughened surface and a more diffuse reflection of incident light, as illustrated in FIG. 2, the use of such filler materials can also adversely affect other important properties of the system. For example, a filler material used in a photopolymerizable system can absorb light, adversely affecting the curing characteristics of the system. The use of filler materials can also affect the structural integrity of a resulting polymer composition. Exemplary traditional filler materials include, without limitation, inert matting agents, such as silica or micronized waxes.

Secondary or post polymerization processing steps used to reduce gloss can include mechanical and/or chemical techniques to roughen the surface and thus, reduce the specular reflection of incident light. Exemplary mechanical techniques can include sanding, grinding, blasting, machining, and other mechanical abrasion techniques in which polymerized material is removed to form a micro-roughened surface. Such mechanical techniques typically require additional processing steps and can produce varying quantities of waste material. Other mechanical techniques to produce a roughened surface can include embossing or transfer molding, but these techniques can require expensive equipment and cleaning steps for the embossing tool or transfer mold. Chemical techniques, such as chemical etching and dissolution, can also be used to provide a roughened or textured surface and to reduce gloss. However, these methods typically require controlled environments and can generate potentially hazardous waste streams.

Thus, there is a need in the art for improved photopolymerization methods that can control the surface morphology and gloss of the resulting polymer composition without requiring the conventional use of added filler materials or secondary mechanical or chemical processing steps. By not requiring the use of conventional techniques for controlling surface morphology and gloss, it is contemplated that these improved methods can produce photopolymerized compositions having controlled surface morphology and gloss characteristics without, for example, adversely affecting physical or chemical properties of the polymer system, generating waste streams, or adding unnecessary cost or processing steps. These and other needs can be satisfied by various aspects of the inventive methods described and disclosed below.

### SUMMARY OF THE INVENTION

The present invention is directed to improved methods for producing photopolymerized compositions having controlled surface morphologies. In one aspect, the methods of the present invention are capable of providing photopolymerized compositions having a controlled surface morphology without requiring the use of conventional additives or secondary processing steps. The methods of the present invention generally comprise a two step illumination process. In a first illumination step, a photopolymerization system is illuminated with light according to a predetermined spatial and temporal illumination scheme. The predetermined spatial and temporal illumination scheme enables that patterning of varying regions of light intensity which in turn initiates polymerizations at differential rates across the photopolymerization system. The patterned spatial and temporal illumination step is generally followed by a second flood cure illumination step in which the entire system is subsequently illuminated at an intensity such that the final cured product is uniformly polymerized.

The spatial and temporal control of the first illumination scheme enables the production of a polymer having a desired surface morphology. During the first patterned illumination step, regions of the polymerization system not undergoing polymerization, or at least undergoing polymerization at a relatively lower rate, can provide monomer for migration to those areas that are undergoing polymerization at a higher rate. This monomer migration results in changes in the surface morphology which, after the flood cure illumination step results in a textured surface on the cured polymer composition. In one aspect, the controlled surface morphology enables a photopolymerized composition to be produced having predetermined gloss characteristics. Further, the resulting textured surface can be optimized to provide a diffuse reflection of light and an apparent reduced gloss characteristic. It is contemplated that the methods of the present invention can be used with any photopolymerization system, including but not limited to photopolymerization systems comprised of industrially important acrylate monomers, which are typically high in gloss.

The methods of the present invention do not require the usage of chemical gloss reducing agents, such as micronized waxes or silica in order to achieve a desired surface morphology. Additionally, the methods of the present invention do not require additional mechanical processing such as embossing, abrading, sanding, blasting, etc.

In one aspect, the present invention provides a method for producing a photopolymerized polymer composition having a controlled gloss. The method generally comprises providing a photopolymerization system comprising at least one photopolymerizable monomer and a photo-initiator. A predetermined spatial and temporal illumination scheme is selected and a surface portion of the photopolymerization system is illuminated with light according to the selected predetermined temporal and spatial illumination scheme to initiate polymerization of a first portion of the monomer. A remaining portion of the photopolymerization system is then illuminated in a flood cure step to polymerize the remaining portion of the monomer and to provide a cured polymer composition having a predetermined gloss.

In another aspect, the present invention provides a method for producing a photopolymerized polymer composition having a predetermined surface morphology. The method according to this aspect generally comprises providing a photopolymerization system comprising at least one photopolymerizable monomer and a photo-initiator. A predetermined spatial and temporal illumination scheme is selected and a surface portion of the photopolymerization system is illuminated with light according to the selected predetermined temporal and spatial illumination scheme to initiate polymerization of a first portion of the monomer. A remaining portion of the photopolymerization system is then illuminated in a flood cure step to polymerize the remaining portion of the monomer and to provide a cured polymer composition having the predetermined surface morphology.

In still another aspect, the present invention provides the photopolymerized compositions produced by the methods disclosed herein.

Additional embodiments of the invention will be set forth, in part, in the detailed description, and any claims which follow, and in part will be derived from the detailed description, or can be learned by practice of the invention. It is to be understood that both the foregoing general description and the following detailed description are exemplary and explanatory only and are not restrictive of the invention as disclosed.

### BRIEF DESCRIPTION OF THE DRAWINGS

The accompanying drawings, which are incorporated in and constitute a part of this specification, illustrate certain embodiments of the instant invention and together with the description, serve to explain, without limitation, the principles of the invention.

FIG. 1 schematically illustrates a comparison of specular reflection exhibited by a smooth surface and diffuse reflection exhibited by a textured or micro-rough surface.

FIG. 2 schematically illustrates the conventional use of silica fillers to provide a micro-roughening or textured surface on a polymer system, giving a matte finish.

FIG. 3 schematically illustrates the illumination and detection scheme carried out when using a glossmeter. As shown, direct illumination and detection of reflected light are typically done at specified angles depending on the level of gloss measured for the surface.

FIG. 4 illustrates an exemplary structured or patterned illumination of a photopolymerization system film according to one aspect of the present invention. The film is illuminated with light according to a predetermined spatial and temporal illumination scheme. The illumination begins at time zero and subsequent monomer migration occurs until time t₁.

FIG. 5 is a schematic representation of anisotropic gloss reduction resulting from a uniformly directional spatial illumination scheme. As shown, higher gloss readings are measured in the parallel axis when compared to the perpendicular axis of measure.

FIG. 6 is a schematic cross-section comparison of standard flood cured system and a structurally illuminated system showing the potential of structured illumination as a method to reduce gloss in photopolymerized coatings.

FIG. 7 is a schematic illustration of the experimental setup used in the appended examples. Illustrated are the light source, inerting chamber, brass sieve (mask openings not portrayed in drawing) and coated Q-panel.

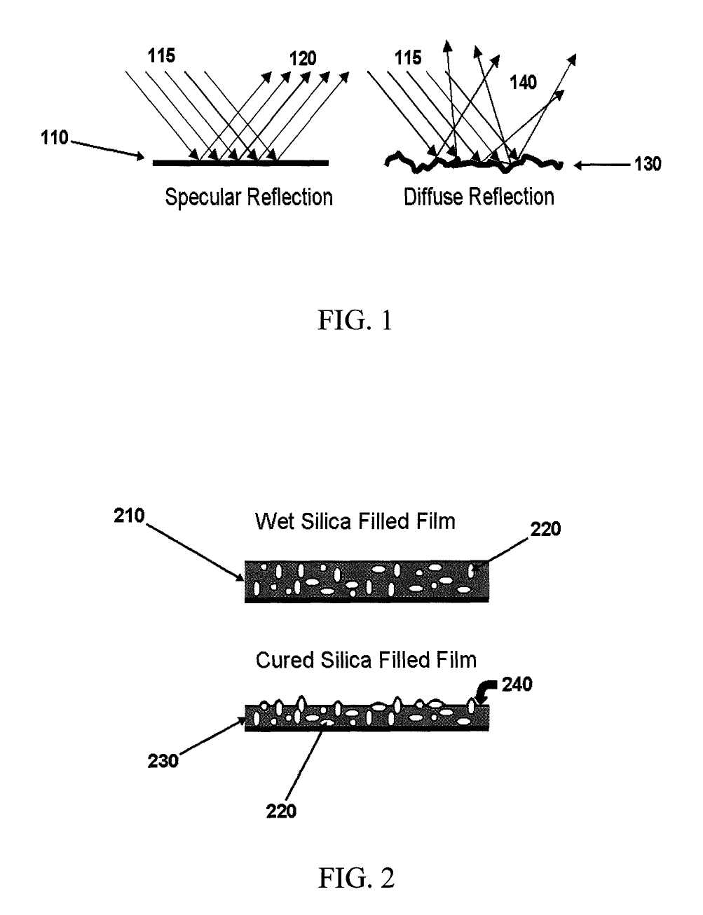

### DETAILED DESCRIPTION

The following description of the invention is provided as an enabling teaching of the invention in its best, currently known embodiment. To this end, those skilled in the relevant art will recognize and appreciate that many changes can be made to the various embodiments of the invention described herein, while still obtaining the beneficial results of the present invention. It will also be apparent that some of the desired benefits of the present invention can be obtained by selecting some of the features of the present invention without utilizing other features. Accordingly, those who work in the art will recognize that many modifications and adaptations to the present invention are possible and can even be desirable in certain circumstances and are a part of the present invention. Thus, the following description is provided as illustrative of the principles of the present invention and not in limitation thereof.

In this specification and in the claims which follow, reference will be made to a number of terms which shall be defined to include the following meanings.

As used in the specification and the appended claims, the singular forms “a,” “an,” and “the” include plural referents unless the context clearly dictates otherwise. Thus, for example, reference to “an initiator” includes mixtures of initiators; reference to “a monomer” includes mixtures of two or more such monomers, and the like.

“Optional” or “optionally” means that the subsequently described event or circumstance may or may not occur, and that the description includes instances where said event or circumstance occurs and instances where it does not. For example, the phrase “optional filler material(s)” means that an optional filler material may or may not be present and that the description includes aspects where an optional filler material is present and, alternatively, aspects where filler material is not present.

Ranges may be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

References in the specification and concluding claims to parts by weight, of a particular element or component in a composition or article, denote the weight relationship between the element or component and any other elements or components in the composition or article for which a part by weight is expressed. Thus, in a compound containing 2 parts by weight of component X and 5 parts by weight component Y, X and Y are present at a weight ratio of 2:5, and are present in such ratio regardless of whether additional components are contained in the compound.

A weight percent of a component, unless specifically stated to the contrary, is based on the total weight of the formulation or composition in which the component is included.

By the term “effective amount” of a composition or property as provided herein is meant such amount as is capable of performing the function of the composition or property for which an effective amount is expressed. As will be pointed out below, the exact amount required will vary from process to process, depending on recognized variables such as the composition employed and the processing conditions observed. Thus, it is not possible to specify an exact “effective amount.” However, an appropriate effective amount may be determined by one of ordinary skill in the art using only routine experimentation.

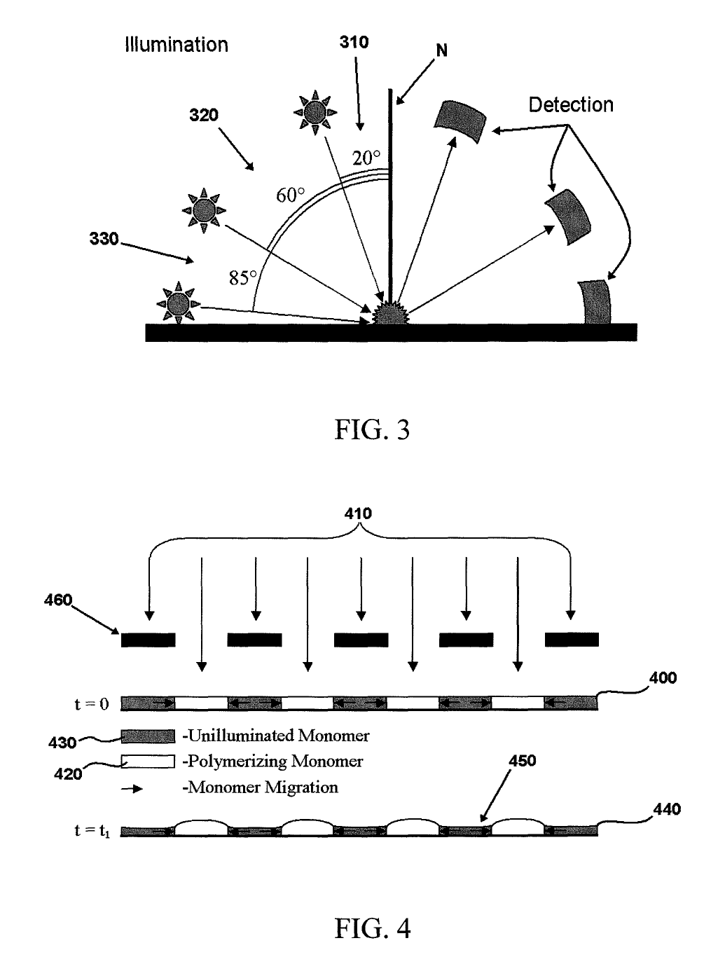

The term “gloss” as used herein refers to the reflection of light incident on the surface of a polymer composition. The gloss of a surface can be quantified by measuring the specular reflection of light incident on the surface. As illustrated in FIG. 3, the angle of incidence of the illuminating light and the angle of detection can vary, depending on the surface. Measurement angles for the specular component(s) of reflected light are reported as deviations from surface normal. As shown in FIG. 3, high gloss surfaces are traditionally measured at an angle 310 of approximately 20° from normal “N,” while semi-gloss and matte finish surfaces are traditionally measured at angles 320 and 330 of approximately 60° and 85°, respectively.

As briefly summarized above, described herein are methods for producing photopolymerized polymer compositions exhibiting controlled characteristics of surface morphology and gloss. The methods generally comprise illuminating a photopolymerizable system, comprised of at least one monomer and a photo-initiator, according to a predetermined temporal and spatial illumination scheme. The predetermined spatial and temporal illumination scheme, also referred to herein as a patterned or structured illumination scheme, generally comprises a predetermined patterning of varying light intensities incident on the surface portion of the photopolymerizable system. This patterning of varying light intensities results in photo-initiated polymerization of the at least one monomer at differential polymerization rates across the surface of the photopolymerizable system. After exposure to the initial patterned or structured illumination step, the photopolymerizable system is then subjected to a conventional flood cure step to at least substantially uniformly cure any remaining uncured or unpolymerized portion of the photo-polymerization system. As described further below, differential rates of polymerization initiated by the structured or patterned illumination result in the formation of surface irregularities or texturing, such as a micro roughening, on the surface of the final polymerized composition.

As will be appreciated by one of skill in the art and as described in connection with the background of the invention, the gloss characteristics of a polymer composition can be dependent, at least in part, upon the existence of irregularities or texturing on the surface of the polymer. Thus, by illuminating a photopolymerizable system according to a predetermined temporal and spatial illumination scheme of the present invention, a polymer having a desired pattern of surface irregularities or texturing and, thus, desired gloss characteristics, can be produced. Still further, these desired gloss characteristics can be achieved without the need for any conventional chemical additives or post polymerization processing steps, currently in use heretofore.

Initially, it should be understood that the structured or patterned illumination schemes of the present invention can be used in connection with any photopolymerizable system comprising at least one monomer and at least one photo-initiator. In one aspect, the photopolymerizable system can comprise any kind of monomer or combination of monomers that undergo free radical polymerization. Some exemplary classes of monomer that undergo free radical polymerizations include, but are not limited to, acrylates, methacrylates, styrene, α-methyl styrene, 1,3-dienes, halogenated olefins, vinyl esters, acrylonitrile, methacrylonitrile, acrylamide, and methacrylamide. In an exemplary aspect, and as exemplified in the appended examples, the monomer component can comprise a combination of hexane diol diacrylate (HDDA) and bisA epoxy acrylate (EA) monomers. To that end, the desired selection and amount of monomer will depend, at least in part, upon the desired polymer to be formed. Accordingly, one of ordinary skill in the art will be able to readily determine which monomer(s) to use for achieving a desired polymer without requiring any undue experimentation.

Similarly, it should also be understood that the photopolymerization system can comprise any photo-initiator capable of initiating a polymerization reaction of the monomer by absorbing light from the predetermined illumination scheme. In one aspect, the photoinitiator is capable of initiating free radical polymerization when subjected to an appropriately selected illumination scheme. To that end, the photoinitiator can be a single chemical component that produces free radicals by unimolecular photolysis upon absorption of light. Exemplary single-component photo-fragmentation photoinitiators include, but are not limited to, hydroxyl alkyl ketone (HAP), 4-(2-hydroxyethoxy)phenyl-(2-hydroxy-2-propyl)ketone (HPPK), methyl thio phenyl morpholino ketone (TPMK), or sulfonic ester of α-hydroxy methyl benzoin derivatives. Alternatively, the photoinitiator can be a hydrogen abstraction photoinitiator which comprises a component that produces free radicals by hydrogen abstraction upon absorption of light. In the excited state these molecules can abstract a hydrogen atom from a wide variety of compounds including alcohols, furans, water, amines, thiols, and others. Exemplary hydrogen abstraction photoinitiators include, but are not limited to, iodonium salt, triaryl sulfonium salt, amino ketone (for example, 4-morpholino phenyl amino ketone), acetophenone, benzophenone, thioxanthone, or benzyl. In an exemplary aspect, and as exemplified in the appended examples, the photoinitiator can be bis-acylphosphine oxide (BAPO). To that end, it should be understood that the optimum photoinitiator and the amount thereof within the photopolymerizable system will depend on several factors including, for example, the wavelength of light used to illuminate the photopolymerization system, and the specific monomer or combination of monomers to be polymerized. Accordingly, one of ordinary skill in the art will be able to readily determine which photoinitiator to use and the desired amount thereof without requiring any undue experimentation.

Still further, the photo-polymerization system can optionally comprise one or more additives including, for example, co-monomer(s), surfactant(s), colorant(s), e.g., dye(s) or pigment(s). In addition, although the method of the present invention is effective for controlling gloss in the absence of conventional gloss reducing or matting agents such as micronized waxes or inorganic additives such as silica, titania, zeolites, clays, aluminas, etc, it should be understood that these conventional gloss reducing agents can optionally be present in the polymerization system if desired. Accordingly, the methods of the present invention include aspects where gloss reducing agents are present and, alternatively, aspects where gloss reducing agents are at least substantially absent.

Once a desired polymerization system comprising the at least one monomer and at least one photo-initiator has been provided, the photopolymerization system can then be illuminated with light according to a predetermined spatial and temporal illumination scheme selected to provide a polymer composition having a desired surface texturing or surface irregularities. Without intending to be bound by any particular theory, it is believed that the surface texturing or irregular surface features resulting from the inventive process are due, at least in part, to monomer migration from areas which remain relatively dark or unilluminated during the structured illumination step to those which are illuminated.

An exemplary illustration of monomer migration resulting from a predetermined spatial and temporal pattern of illumination is shown schematically in FIG. 4. As shown, a polymerization system 400 is provided at time zero (t=0) and is subjected to a predetermined spatial pattern of illumination 410 such that portions 420 of the polymerization system are illuminated and portions 430 remain unilluminated. As indicated by the arrows, unilluminated monomer present within the polymerization system migrates from the unilluminated portions 430 toward the illuminated portions 420 where monomer is undergoing polymerization. After a predetermined period of time (t=t₁), the monomer migration during polymerization results in a polymerized film 440 having an irregular or textured surface 450.

The predetermined spatial and temporal illumination scheme can be selected to provide any desired surface morphology of the resulting polymer composition. To that end, the spatial illumination pattern of the illumination scheme refers to the variation in light intensity incident on the surface of the polymerization system as a function of location in a two-dimensional plane. By varying the spatial pattern, the method of the present invention can control the gloss characteristic of the resulting polymer by providing virtually any desired surface morphology, texture, or roughness in the final cured product. For example, the method of the present invention can be used for producing photopolymerized polymer surfaces exhibiting any desired value of gloss, ranging from a high gloss finish to matte finishes.

Once determined, the spatial illumination pattern can be provided by any conventional means suitable for generating a pattern of varying light intensity incident on the surface of the polymerization system. In one aspect, and as shown in FIG. 4, the spatial illumination pattern can be generated by a conventional masking technique whereby a surface portion of the polymerization system is masked by a mask 460 configured according to a predetermined pattern. According to this aspect, when the polymerization system is illuminated, only those portions of the polymerization surface that remain unmasked are illuminated with the light. In an alternative aspect, the spatial illumination pattern can be generated by a projection technique or by an interference pattern resulting from two or more light sources.

It should be understood that there are many variables that can be associated with the desired design and selection of the illumination pattern. For example, in one aspect, the size and shape of a particular surface feature can be optimized by selection of a particular spatial illumination pattern. In another aspect, the selection of a spatial illumination scheme can be dependent upon the desired gloss to be achieved, ranging from a high gloss finish to a matte finish. Additionally, the spatial relationship between the dark and light regions of the illumination scheme can also be optimized according to the desired surface morphology to be achieved. For example, in one aspect, and as shown again in FIG. 4, the spatial illumination scheme can be selected to provide clearly defined portions where light is incident on the surface of the polymerization surface together with clearly defined portions where substantially no light is incident on the surface of the polymerization system. Alternatively, rather than clearly defined portions, the spatial illumination scheme can be selected to provide varying gradients of light intensity incident across the surface of the polymerization surface and between illuminated and dark regions of the surface. To this end, it should be understood that there are virtually an unlimited number of spatial illumination patterns that can be used according to the present invention. Further, one of ordinary skill in the art will be able to readily determine, without undue experimentation, a particularly desired spatial illumination pattern for providing a desired photopolymerized polymer surface morphology and, thus, a polymer surface having a particularly desired gloss characteristic.

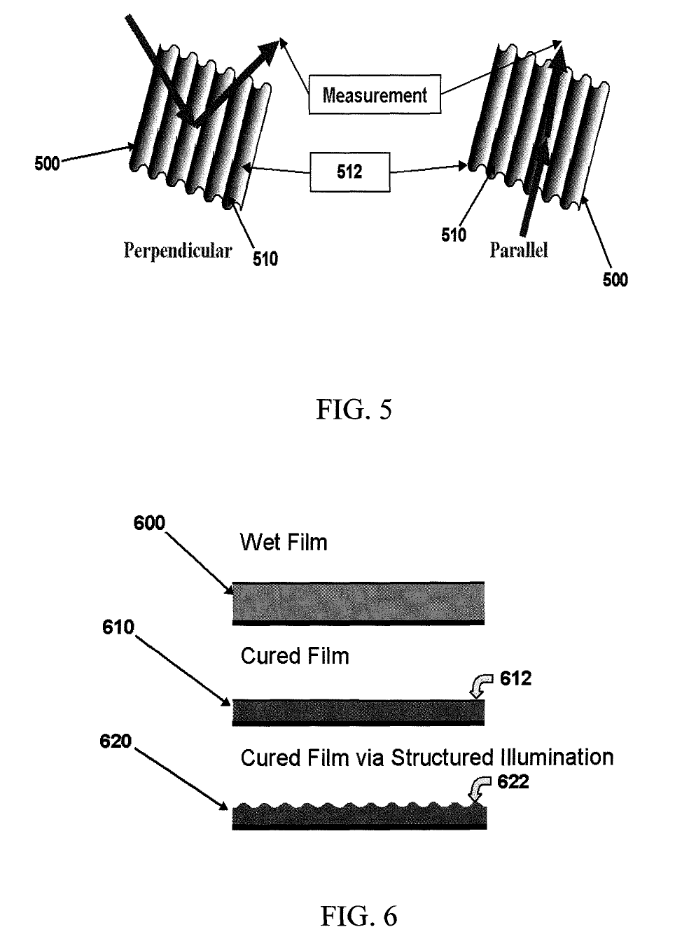

In still another aspect of the present invention, the method can be used to provide a polymer surface having differential gloss characteristics. As used herein, a differential gloss includes a surface exhibiting gloss characteristics that vary depending on a particular viewing angle. Additionally, a photopolymerized surface can also be obtained having varying gloss values, depending on spatial location and depending upon different patterning of light incident on various surface portion of the polymerization system. Still further, the method of the present invention can also be used to obtain anisotropic or directionally dependent gloss reduction. For example, uniformly directional line masks can be used to provide a differential gloss reduction depending on the direction and/or angle of gloss measurement. An exemplary schematic illustration of anisotropic gloss reduction is shown in FIG. 5. As shown, a polymerized film 500 is provided having a textured surface 510. The textured surface 510 is comprised of a plurality of patterned surface features 512. Based upon the exemplified film, a higher gloss value can be seen when making a measurement generally parallel to the direction of the patterned lines. In contrast, rotating the sample 90° in order to measure gloss at an axis perpendicular to the patterned lines gives a lower apparent gloss value.

In an alternative aspect, a spatial illumination scheme can be selected to provide multi-directional texturing of the polymer surface. According to this aspect, the multi direction texturing will typically provide a more diffuse reflection of light, resulting in a more uniform gloss across the surface of the polymer. To this end, multi directional spatial illumination schemes can, in one aspect, provide a greater reduction of gloss with relatively less or even no dependence on viewing axis. Multi directional illumination patterns can, for example, be generated using a cross hatched or camouflage design masking patterns.

For effective gloss control according to the present invention, the light source should be capable of enabling substantial curing or polymerization to take place during the time in which the patterned or structured illumination step takes place. For a given photopolymerization system, in addition to the spatial patterning, the structured illumination variables can also include the intensity or irradiance, illumination time, and wavelength. For example, if the wavelength of light being emitted does not match that of the light which can be absorbed by the photoinitiator, then a sufficient cure will not take place. To that end, the wavelength of light suitable for illuminating the photopolymerization system can be any wavelength within and ranging from the ultraviolet (UV) region to the infrared (IR) region, and including visible light. For example, in one aspect, the wavelength of light can be in the range of from 180 nm to 1 micron (μm). To that end, it will be appreciated that the choice of wavelength will depend on the choice of photoinitiator used to initiate the polymerization reaction upon absorption of a particular wavelength of light (likewise, choice of photoinitiator can be dependent on the desired wavelength of illumination as discussed above).

In addition to the wavelength of light, the intensity and duration of the structured illumination step can be predetermined as well. For example, once the light is determined to be of the correct wavelength to be absorbed by the photoinitiator, the duration of the structured illumination (temporal component) and the intensity of the light should be sufficient to result in enough polymerization to take place in the illuminated regions to set up a concentration gradient for diffusion or to result in sufficient shrinkage for monomer microflow, as shown in FIG. 4. It will be understood that the desired wavelength of illumination, intensity of illumination, and the duration of structured illumination, will vary and can be readily determined by one of ordinary skill in the art without requiring any undue experimentation.

Following the structured or patterned illumination step, the photo-polymerization system is then subjected to a flood cure step to polymerize any remaining unpolymerized portion of the photopolymerization system. As described above in connection with the structured illumination scheme, the flood cure step also comprises illuminating the photopolymerization system with light of an appropriately selected wavelength, intensity, and for a duration sufficient to ensure that the remainder of the photopolymerization system is at least substantially uniformly polymerized. However, as a flood cure step, and in contrast the structured illumination step, the flood cure illumination scheme is not patterned according to a predetermined spatial scheme. Further, the appropriate wavelength and intensity of light, and the appropriate duration for the flood cure step can once again be readily determined by one of ordinary skill in the art without requiring any undue experimentation.

The method of the present invention can be performed in either a batch wise or continuous process. In an exemplary continuous method, a photopolymerization system can be continuously conveyed through a structured or patterned illumination system according to the present invention. For example, the structured illumination system can comprise a continuous web mask which is conveyed concurrently along with the polymerization system. While being conveyed, the polymerization system is subjected to an appropriate wavelength and intensity of light from a light source. The light is patterned onto the surface of the polymerization system as a result of the continuous web mask moving concurrently with photopolymerization system.

In an alternative aspect, it is also contemplated that a continuous structured illumination processes can comprise the use of a stationary mask. According to this aspect, a flash lamp can be used to supply a sufficient wavelength and intensity of light in order to illuminate the photopolymerization system as it is conveyed past the stationary mask. Pulsed illumination from the flash lamp can be synchronized to the speed of the conveyor belt in order to ensure an appropriate duration for the spatial illumination scheme.

In both aspects, the distance of the mask from the surface of the polymerization system can be optimized to ensure that, for example, light does not bleed to the intended darker regions of the photopolymerization surface where light is intended to be masked. To that end, in one aspect, it is desirable for the mask to be positioned as close to the surface of the polymerization system as possible.

In still another aspect, the present invention provides the polymer compositions produced by the inventive methods disclosed herein. To that end, the method of the present invention can be used to prepare thin polymer films or coatings having controlled gloss that are suitable for use in various display technologies. Alternatively, the method can be used to prepare films which reduce glare. In another aspect, the method can be used to produce thin polymeric films for wood coatings where lower gloss may be preferred over higher gloss coatings. Still further, the method of the present invention can be used to provide paints and coatings exhibiting a variety of finishes, printing to produce textured images, optical films such as light diffusers, anti-reflective and directionally reflective films, packaging and any other film or coating application where gloss control of a polymeric surface may be desired.

It will be appreciated upon practicing the present invention that, by using a predetermined spatial and temporal illumination scheme there is no need for the use of chemical additives and therefore no significant change in the curing kinetics of the photopolymerization system. Additionally, there similarly is no need for conventional mechanical processing to provide the desired surface morphology as the texture or roughness obtained using structured illumination is affected by the pattern of the light incident on the surface of the monomer, the intensity of the light, the thickness of the coating and the concentration of initiator. To this end, FIG. 6 schematically illustrates how structured illumination of the present invention can mimic the surface modifications previously achieved with conventional additives and mechanical processing. As shown, a film of wet or uncured polymerization system 600 is provided. Polymerizing the film 600 in the absence of any predetermined spatial or temporal illumination scheme can provide cured film 610 having a smooth surface 612, thus providing a relatively high gloss finish. In contrast, polymerizing film 600 according to a structure illumination scheme as described herein can provide cured film 620, having a roughened or textured surface 622, thus providing a reduced gloss finish, such as for example a matte finish.

### EXAMPLES

To further illustrate the principles of the present invention, the following examples are put forth so as to provide those of ordinary skill in the art with a complete disclosure and description of how the articles, devices, and methods claimed herein are made and evaluated. They are intended to be purely exemplary of the invention and are not intended to limit the scope of what the inventors regard as their invention. Efforts have been made to ensure accuracy with respect to numbers (e.g., amounts, temperatures, etc.); however, some errors and deviations should be accounted for. Unless indicated otherwise, temperature is ° C. or is at ambient temperature, and pressure is at or near atmospheric. There are numerous variations and combinations of process conditions that can be used to optimize product quality and performance. Only reasonable and routine experimentation will be required to optimize such process conditions.

### Example 1

### Preparation of HDDA and EA Photopolymerization System Films

In a first example, polymerization system films were prepared from hexane diol diacrylate (HDDA) and bisA epoxy acrylate (EA) monomers, having the chemical structures (I) and (II) respectively.

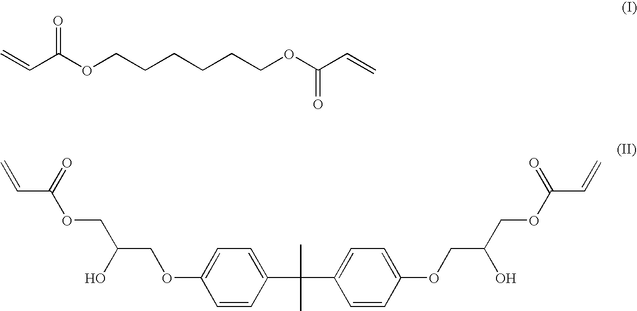

Both the HDDA and EA monomers are widely used in coating applications and are di-functional acrylates which can cross-link to provide tough, mar resistant, and brittle coatings. When used in a conventional photopolymerization process, HDDA and EA can provide high gloss finishes.

The HDDA and EA monomers were mixed in a 1:1 wt. ratio and initiated by addition of 1 wt. % of bis-acylphosphine oxide (BAPO) having the chemical structure (III) below and commercially available as IrgaCure® 819 from Ciby-Geigy Corporation (Tarrytown, N.Y., USA). BAPO initiates a free radical polymerization by cleaving at the phosphorus upon exposure to near-UV radiation.

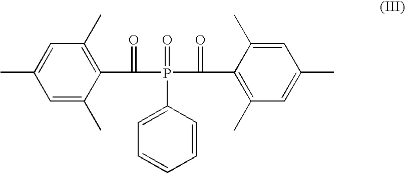

Films were deposited on 3 in. by 6 in. stainless steel Q-panels (available from ACT Laboratories). Prior to deposition, the panels were coated with red epoxy spray paint to reduce the gloss of the panel itself and eliminate interference from the reflection of light off the bare metal substrate. A 500 μL aliquot of the initiated monomer mixture prepared above was then applied in a thin line near the top of each Q-panel using a 1000 μL precision pipette. To ensure consistent coverage and coating thicknesses, the width of each applied line was kept constant.

After deposition, a #80 wire wound applicator rod was used to evenly distribute the initiated monomer mixture across each Q-panel.

### Example 2

### Illumination of Coated O-Panels

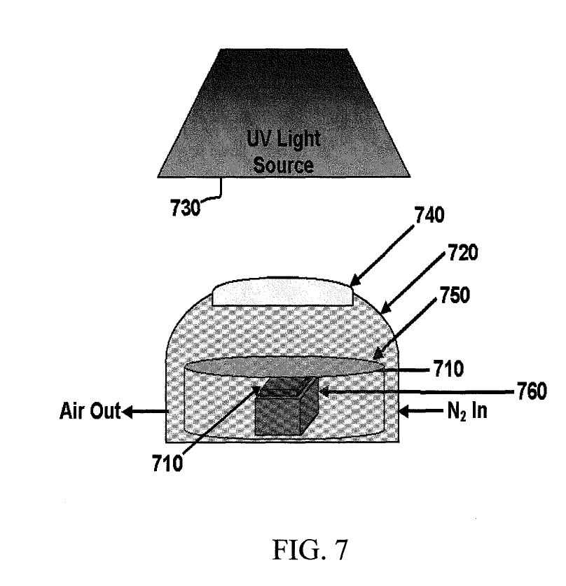

In a second example, and as schematically shown in FIG. 7, the coated Q-panels prepared in Example 1 were illuminated by UV light under a brass sieve mask. After distribution of the initiated monomer mixture, each Q-panel 710 was placed in a sealed inerting chamber 720 positioned underneath an ultraviolet light source 730 (Hybrid Technologies Corporation, model 63-10) having a UV-A intensity of 160 mW/cm². The coated Q-panels 710 were positioned approximately 10 inches from the light source, centered under the 6 in. quartz window 740 at the top of the inerting chamber and directly beneath a brass sieve mask 750. The Q-panels were adjusted using spacer blocks 760 to place the coating as close to the sieve mask as possible.

Multiple experiments were conducted using various sized sieves. The ASTM wire thickness and mesh opening dimensions for each sieve are detailed in Table 1, below.

TABLE 1

| | | |
|---|---|---|
| | MESH | WIRE |
| U.S. Sieve # Wire | OPENING | DIAMETER |

| Mesh Size | inches | mm | inches | mm |
|---|---|---|---|---|
| 80 | 0.007 | 0.18 | 0.0052 | 0.131 |
| 100 | 0.0059 | 0.15 | 0.0043 | 0.11 |
| 120 | 0.0049 | 0.125 | 0.0036 | 0.091 |
| 140 | 0.0041 | 0.106 | 0.003 | 0.076 |
| 170 | 0.0035 | 0.09 | 0.0025 | 0.064 |
| 200 | 0.0029 | 0.075 | 0.0021 | 0.053 |
| 230 | 0.0025 | 0.063 | 0.0017 | 0.044 |
| 270 | 0.0021 | 0.053 | 0.0015 | 0.037 |
| 325 | 0.0017 | 0.045 | 0.0012 | 0.03 |

After each Q-panel was placed in the inerting chamber, a cover was positioned over the inerting chamber to prevent any light from reaching the coating. The inerting chamber was then purged with nitrogen for approximately five minutes to eliminate the effects of oxygen inhibition on the photopolymerization process. After purging, the cover to the inerting chamber was removed and the coated Q-panel was illuminated for 60 seconds. The brass sieve mask was then removed and the coated Q-panel was flood cured by illuminating for an additional 60 seconds to complete the polymerization.

### Example 3

### Measurement of Gloss

In a third example, the gloss of coatings photopolymerized in Example 2 were measured. Gloss measurements were conducted using a Byk Gardner micro-tri-gloss meter which can determine coating thickness and gloss at 20° (high gloss), 60° (semi-gloss), and 85° (matte) angles. Each sample was analyzed six times, three times perpendicular to the length of the coated panel and three times parallel to the length of the coated panel. Average gloss measurements are listed in Table 2, along with average coating thickness (standard deviation of 6 μm).

TABLE 2

| U.S. Sieve # | 20° | 60° | 85° | Thickness |
|---|---|---|---|---|
| Wire Mesh Size | (High Gloss) | (Semi-Gloss) | (Low Gloss) | (μm) |
| none | 91.4 | 95.9 | 97.6 | 143 |
| 80 | 4.9 | 26.6 | 32.0 | 141 |
| 100 | 4.7 | 26.7 | 30.3 | 147 |
| 120 | 4.5 | 24.5 | 25.1 | 143 |
| 140 | 4.6 | 23.8 | 22.9 | 138 |
| 170 | 5.6 | 32.2 | 38.4 | 145 |
| 200 | 4.1 | 23.3 | 32.0 | 140 |
| 230 | 7.4 | 41.7 | 57.9 | 137 |
| 270 | 7.0 | 46.7 | 68.3 | 139 |
| 325 | 72.6 | 94.8 | 94.6 | 142 |

The results detailed in Table 2 illustrate the control and reduction in gloss that can be achieved through the structured illumination technique of the present invention. The unmasked sample (“none”) that was only subjected to a flood cure illumination exhibited an extremely high gloss surface, while virtually all of the structured illumination samples exhibited substantially reduced gloss. Structured illumination followed by a flood cure step can thus be used to provide photopolymerized polymer compositions exhibiting a range of apparent gloss values, including gloss values within the range considered to be “low gloss.”

What is claimed is:

1. A method for producing a photopolymerized polymer composition having a controlled gloss, the method comprising the steps of:
a) providing a photopolymerization system comprising at least one photopolymerizable monomer and a photo-initiator;
b) selecting a predetermined spatial and temporal illumination scheme;
c) illuminating a surface portion of the photopolymerization system with light according to the selected predetermined temporal and spatial illumination scheme to initiate polymerization of a first portion of the monomer, wherein the initiated polymerization occurs in a pattern of differential polymerization rates across the surface portion of the photopolymerization system; and
d) illuminating a remaining portion of the photopolymerization system to polymerize the remaining portion of the monomer and to provide a cured polymer composition having a predetermined gloss.

2. The method of claim 1, wherein the at least one monomer comprises an acrylate monomer.

3. The method of claim 1, wherein the light is at a wavelength in the range of from 180 nm to 1 micron (μm).

4. The method of claim 1, wherein the predetermined spatial illumination scheme is a uniformly directional spatial scheme.

5. The method of claim 1, wherein the predetermined spatial illumination scheme is a multi-directional spatial scheme.

6. The method of claim 1, wherein the predetermined gloss is anisotropic.

7. The method of claim 1, wherein the photopolymerization system does not comprise a gloss reducing agent.

8. The method of claim 1, wherein the method does not comprise a post polymerization gloss processing step.

9. The method of claim 9, wherein the post polymerization gloss processing step is selected from etching, embossing, dissolution, and abrasion.

10. The method of claim 1, wherein the cured polymer having the predetermined gloss is a thin film.

11. The method of claim 1, wherein step c) comprises masking a surface portion of the photopolymerization system and wherein the masked surface portion corresponds to the predetermined spatial illumination scheme.

12. The method of claim 1, wherein step c) comprises illuminating a surface portion of the photopolymerization system with light from a plurality of light sources and wherein the plurality of light sources provide an interference pattern corresponding to the predetermined spatial illumination scheme.

13. A photopolymerized polymer composition produced by the method of claim 1.

14. A method for producing a photopolymerized polymer composition having a predetermined surface morphology, the method comprising the steps of:
a) providing a photopolymerization system comprising at least one photopolymerizable monomer and a photo-initiator;
b) selecting a predetermined spatial and temporal illumination scheme;
c) illuminating a surface portion of the photopolymerization system with light according to the selected predetermined temporal and spatial illumination scheme to initiate polymerization of a first portion of the monomer, wherein the initiated polymerization occurs in a pattern of differential polymerization rates across the surface portion of the photopolymerization system; and
d) illuminating a remaining portion of the photopolymerization system to polymerize the remaining portion of the monomer and to provide a cured polymer composition having the predetermined surface morphology.

15. The method of claim 14, wherein the predetermined surface morphology is selected to provide a polymer having a predetermined gloss.

16. The method of claim 14, wherein the light is at a wavelength in the range of from 180 nm to 1 micron (μm).

17. The method of claim 14, wherein the predetermined spatial illumination scheme is a uniformly directional spatial scheme.

18. The method of claim 14, wherein the predetermined spatial illumination scheme is a multi-directional spatial scheme.

19. The method of claim 14, wherein the predetermined gloss is anisotropic.

20. The method of claim 14, wherein the predetermined surface morphology is provided in the absence of a post polymerization processing step.

21. The method of claim 20, wherein the post polymerization processing step is selected from etching, embossing, dissolution, and abrasion.

22. The method of claim 14, wherein the cured polymer having the predetermined surface morphology is a thin film.

23. The method of claim 14, wherein step c) comprises masking a surface portion of the photopolymerization system and wherein the masked surface portion corresponds to the predetermined spatial illumination scheme.

24. The method of claim 14, wherein step c) comprises illuminating a surface portion of the photopolymerization system with light from a plurality of light sources and wherein the plurality of light sources provide an interference pattern corresponding to the predetermined spatial illumination scheme.

25. A photopolymerized polymer composition produced by the method of claim 14.
